(19) United States
(12) Patent Application Publication
(10) Pub. No.: US 2012/0051026 A1
(43) Pub. Date: Mar. 1, 2012

(54) Method for cooling a light emitting diode with liquid and light emitting diode package using the same

(76) Inventor: Yung Pun Cheng, Macau (CN)

(21) Appl. No.: 13/149,602

(22) Filed: May 31, 2011

(30) Foreign Application Priority Data
Dec. 17, 2010 (CN) 201010593513.X

(51) Int. Cl. F21V 9/16; F21V 29/00

(52) U.S. Cl. 362/84; 362/373

(57) ABSTRACT

A method of directly contacting a light emitting diode with an electrically nonconductive, substantially transparent liquid and an LED package including an LED in contact with an electrically nonconductive, substantially transparent liquid dissipates heat generated by the LED via thermal convection of the liquid. The method and the light emitting diode package may use a first heat-dissipating element in contact with the liquid and a second heat-dissipating element connected to the first heat-dissipating element to further conduct heat away from the LED. The method and the LED package may have excellent heat dissipation properties and may reduce or eliminate the decomposition and aging of a fluorescent powder due to heat and may further reduce light attenuation and color temperature differences.

### CROSS-REFERENCE TO RELATED APPLICATIONS

This patent application relates and claims priority to Chinese patent application no. 201010593513.X filed Dec. 17, 2010, which is herein incorporated by reference for all purposes.

### TECHNICAL FIELD

This disclosure relates generally to the cooling and heat dissipation of a light emitting diode (“LED”) and, more specifically, to a method and package for cooling the LED by encapsulating an LED die with one or more liquids.

### BACKGROUND

With the developments in LED technologies, high-powered LEDs are more frequently being designed for lighting applications, for example, household lighting applications. In contrast with conventional light sources, such as incandescent light bulbs, LEDs possess various advantages, such as sufficient brightness, low energy consumption, high reliability, long lifetime, etc. Furthermore, LEDs have many additional advantages over a traditional incandescent lamp, such as smaller volume, lower heat output, greater reaction rate, and being more environmentally friendly. These advantages have lead to the widespread use of LEDs in various applications in the lighting field.

LEDs are light emitting display devices made of semiconductor materials and are capable of directly converting electrical energy into optical energy. The previously recited advantages of lower power consumption and greater brightness have caused LEDs to be widely used as indicator lights and display panel lights in a wide variety of equipment, such as electronic circuits, household appliances, meters, and the like. LEDs, however, can be negatively affected by high temperatures and their energy conversion efficiencies can rapidly fall at higher temperatures, thereby consuming more electricity and producing more heat, which, in turn, further increases the temperature in the LEDs. Thus, a vicious circle begins and the longevity of the LEDs may be greatly reduced.

If heat from the LEDs is not effectively dissipated, the longevity of the LEDs may be greatly shortened and energy consumption may increase, effectively eliminating two of the greatest advantages of LEDs over incandescent bulbs. Thus, an improved LED heat dissipation technology is desired and is an important task in the field of LED lighting.

### BRIEF SUMMARY

The present disclosure addresses heat dissipation issues, provides a method for cooling an LED with a liquid, and provides an LED package for cooling an LED with a liquid.

A method for cooling an LED with a liquid includes contacting an LED with the liquid and transferring heat generated by the LED from the LED to the liquid thereby dissipating heat via thermal convection. The liquid may be a substantially transparent liquid, and the liquid may be electrically non-conductive. The liquid may comprise water, oil, a chemical polymer, or a combination thereof

According to an aspect, the substantially transparent liquid and the LED may be encapsulated within a vessel. The vessel may be a substantially transparent vessel. Fluorescent powder may be applied to the outer wall of the substantially transparent vessel by spraying the powder on the outer wall or by applying a layer of fluorescent powder membrane on the outer wall of the vessel. The light emitted by turning on the LED may be transmitted through the vessel, to the fluorescent power, and through the fluorescent powder to the outside of the LED package.

According to another aspect, the substantially transparent liquid and the substantially transparent vessel may be provided between a die of the LED and a fluorescent powder applied to the outside of the substantially transparent vessel such that the heat generated from the LED may not be directly transferred to the fluorescent powder, thereby preventing the fluorescent powder from decomposing and aging due to the negative effects of the heat. The light emitted after turning on the LED may transmit through the substantially transparent liquid and through the substantially transparent vessel to the fluorescent powder, and through the fluorescent powder to the outside of the LED package. The light from the LED may excite the fluorescent powder, which serves as a secondary light source, thereby intensifying the light from the LED and/or changing the wavelength (and thus color) of the light from the LED.

According to another aspect, the heat generated by the LED may be conducted via a first heat-dissipating element connected to the substantially transparent vessel. The first heat-dissipating element may be at least partially in contact with the substantially transparent liquid. The heat generated by the LED may be further conducted away from the first heat-dissipating element via a second heat-dissipating element connected to the first heat-dissipating element. The first and second heat-dissipating elements may be heat sinks and, more specifically, may be aluminum or ceramic heat sinks

According to another aspect, the first heat-dissipating element may be provided with one or more protrusions on the surface of the first heat-dissipating element that is in contact with the substantially transparent liquid. The increased surface area of the first heat-dissipating element in contact with the substantially transparent liquid increases the efficiency of the first heat-dissipating element.

According to another aspect, the LED may be soaked together with a plurality of leads in the substantially transparent liquid. The leads soaked in the liquid may be manufactured from metal and may comprise a printed circuit board. According to another aspect, the substantially transparent liquid used in the present disclosure may be water, oil, chemical polymer, or any combination thereof.

The present disclosure also provides an LED package that may comprise an LED die and its leads; a substantially transparent liquid in contact with the LED die; a substantially transparent encapsulating vessel containing the LED die, the leads, and the substantially transparent liquid; a heat sink connected to the substantially transparent encapsulating vessel; and a fluorescent powder located on the outer wall of the substantially transparent encapsulating vessel. The LED package may achieve excellent heat dissipation of the LED die, and thereby may prevent the heat generated by the LED die from directly conducting with the fluorescent powder. By preventing the heat generated by the LED die from directly conducting with the fluorescent power, the powder may be substantially prevented from prematurely decomposing and aging, and the LED may substantially avoid light attenuation and color temperature drifting.

According to another aspect, the LED package may further comprise a secondary heat-dissipating element connected to the primary heat sink, which in turn could be connected to the substantially transparent vessel, to further conduct heat away from the heat sink. The secondary heat-dissipating element is thus located outside the substantially transparent vessel.

### BRIEF DESCRIPTION OF THE DRAWINGS

FIG. 1 illustrates a cross-sectional drawing of a conventional LED and heat sink;

FIG. 2 illustrates a schematic drawing of conventional heat conduction relationship of an LED;

FIG. 3A illustrates a cross-sectional drawing of an LED package cooled by a liquid, in accordance with the present disclosure;

FIG. 3B illustrates a cross-sectional drawing of an LED package with one or more protrusions on a top surface of a first heat sink, in accordance with the present disclosure;

FIG. 4 illustrates a schematic drawing of a heat conduction relationship in LED packages, in accordance with the present disclosure; and

FIG. 5 illustrates a process for cooling LED packages, in accordance with the present disclosure.

### DETAILED DESCRIPTION

LEDs are well known in the art and are currently used in a wide variety of lighting applications. However, LEDs may be negatively affected by high temperatures, resulting in increased power consumption and lower energy conversion efficiency, which results in even higher temperatures.

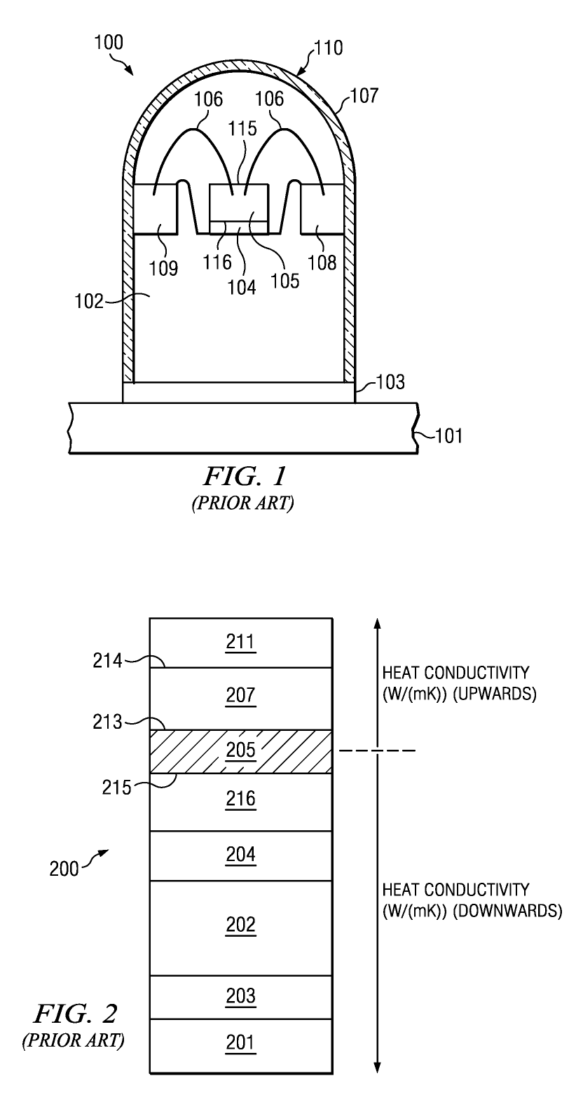

FIG. 1 illustrates a cross-sectional drawing of a conventional LED 100 using the existing heat dissipation technology. The LED 100 includes an aluminum substrate 101, a heat sink 102, adhesive materials 103, 104, an LED die 105, a plurality of leads 106, a mixture of silicone gel and fluorescent powder 107, an anode 108, a cathode 109, and an encapsulate 110. The existing heat dissipation technology used by the LED 100 cannot dissipate the heat from the LED die 105 sufficiently, which may cause heat to accumulate, electrical current to rise, and the fluorescent powder 107 to decompose due to the heat, which may result in light attenuation and color temperature drifting.

The heat sink 102 is mounted on the aluminum substrate 101 by means of the adhesive material 103. The encapsulate 110 surrounds the anode 108 and the cathode 109, which are connected to the LED die 105 by the plurality of leads 106. The LED die 105 is connected to the heat sink base 102 by means of the adhesive material 104. The adhesive materials 103, 104 may include a silver paste, a silicone gel, or a chemical polymer, and are in contact with the LED die 105 to conduct heat energy and transfer the heat away from the LED die 105. In the process of heat transfer, different materials have different heat transfer coefficients; thus, a heat conduction bottleneck may result when using materials with a low heat transfer coefficient (such as die attachment adhesives), resulting in a decreased efficiency of heat conduction.

Furthermore, the source of the heat of the LED die 105 is at a top surface 115 of the LED die 105, rather than on a bottom surface 116 of the LED die 105, and thus having the heat dissipation mechanism at the bottom surface 116 of the LED die 105 has inherent defects. By having the source of the heat at a top surface 115 of the LED die 105, this indirect method of heat dissipation is significantly limited in design, both by heat dissipation indirect interfaces and by the area and volume of the heat dissipation material. As a result, the heat from the LED die 105 accumulates, the efficiency of converting electric energy into optical energy decreases, and light attenuation continuously occurs. Also, because the mixture of fluorescent powder and silicone gel 107 is immediately attached to and in contact with the luminescent layer of the LED die 105, the fluorescent powder and silicone gel 107 absorbs a high level of heat, which may cause the fluorescent powder 107 to decompose due to long term heating. This can cause light attenuation and color temperature drifting.

FIG. 2 illustrates a schematic view of the heat conduction relationship in conventional LED encapsulation technology, for example as used by the LED 100 shown in FIG. 1. FIG. 2 shows a transparent silicone gel layer 211, a fluorescent powder silicone gel mixture layer 207, an LED heat source (die) 205, an LED base 216, a die attachment silver paste 204, a heat sink 202, a heat sink attachment silver paste 203, and an aluminum substrate 201, which in combination constitutes an LED package 200.

In the LED package 200, an upper layer 213 of the LED die 205 generates light (blue, for example) and heat. A mixture of fluorescent power and silicone gel 207 is put on the upper layer 213 of the LED die 205. The emitted blue light from the LED die 205 will go through the fluorescent powder 207 which may change the blue light to white light. A transparent silicone gel layer 211 may be put on top 214 of the fluorescent powder layer 207 to protect the fluorescent powder 207.

The LED die 205 is small in size and further heat dissipation is typically desired. Therefore, the LED die 205 is usually put on a larger heat sink 202 to further direct the heat away from the LED die 205. The LED die 205 is usually put on the heat sink 202 and attached to the heat sink 202 with a thermal conductive paste 204, such as a silver paste.

As shown in FIG. 2, the direction of heat conduction travels away from the LED heat source 205 in at least two directions. The heat may travel in other directions as well, but for illustrative purposes, FIG. 2 shows two directions. The heat conduction may travel from the LED heat source 205 “upwards” (i.e., through the upper layer 213 of the LED die 205) through the fluorescent powder silicone gel layer 207 to the transparent silicone gel layer 211, and may also travel “downwards” (i.e., through the bottom 215 of the LED die 205) through the LED base 216, the die attachment silver paste 204, the heat sink 202, the heat sink attachment thermal paste 203, and finally through the aluminum substrate 201.

Different layers/elements shown in FIG. 2 may have different thermal conductivity. The transparent silicone gel layer 211 may be made of material such as Dow Corning OE6650, which is available from Dow Corning Corporation, and may have a thermal conductivity of 4.0 W/(mK) (watts per meter kelvin). The fluorescent powder silica gel 207 may have a thermal conductivity of 22.0 W/(mK). The LED heat source 205 is the heat source of the LED package 200, and therefore its thermal conductivity is not applicable. The LED base 216 may be made of sapphire and may have a thermal conductivity of 42.0 W/(mK). The die attachment silver paste 204 may be made of DX-20-4, which is available from Emerson & Cuming, and may have a thermal conductivity of 17.8 W/(mK). The heat sink 202 may be made of iron and may have a thermal conductivity of 80.0 W/(mK). The heat sink attachment silver paste 203 may have a thermal conductivity of 40.0 W/(mK). The substrate 201 may be made of aluminum and may have a thermal conductivity of 237.0 W/(mK).

As discussed in the foregoing, the prior-art structure of LED package 100, 200, as shown in FIGS. 1 and 2, has the disadvantage that heat dissipation is insufficient, which causes heat to accumulate, electrical current to rise, and the fluorescent powder to decompose due to heat, which may result in light attenuation and color temperature drifting.

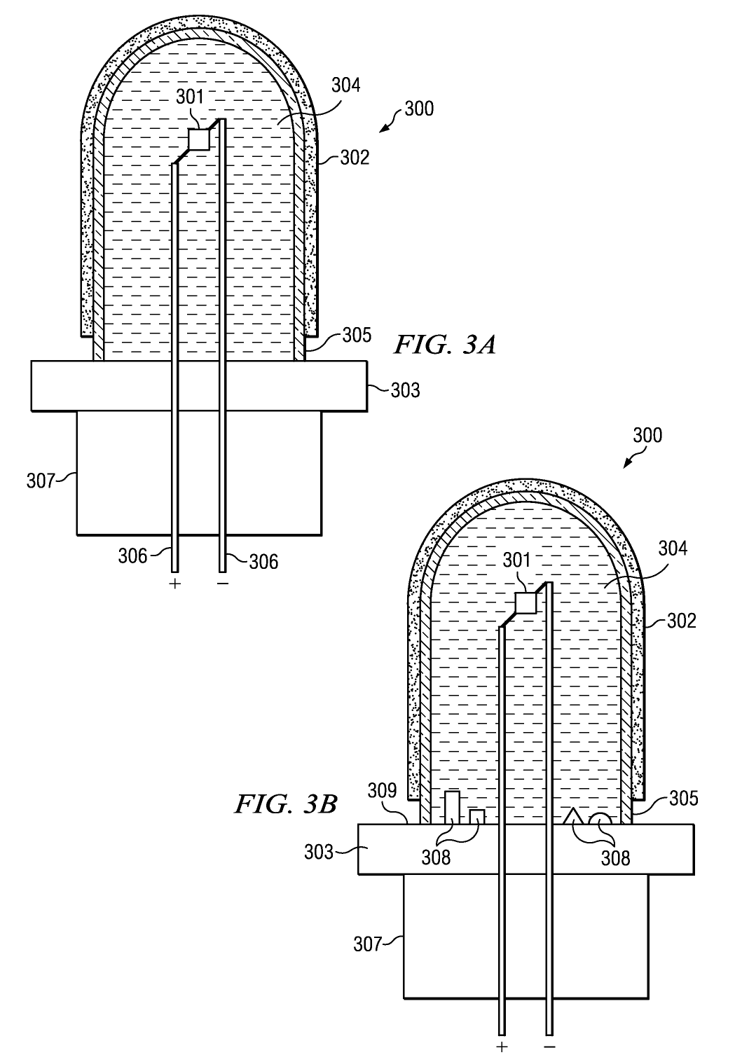

FIG. 3A illustrates a cross-sectional diagram of an LED package 300. The LED package 300 may include an LED die 301, a fluorescent powder silicone gel layer 302, a first heat-dissipating element 303, a substantially transparent liquid 304, a substantially transparent vessel 305, positive and negative leads 306, and a second heat-dissipating element 307.

According to an embodiment, the LED package 300 may be configured with the LED die 301 at least in partial contact with the substantially transparent liquid 304. In an alternative embodiment, the LED die 301 may be completely surrounded by the substantially transparent liquid 304. The substantially transparent liquid 304 may be water oil, a chemical polymer, or any combination thereof. The heat generated by the LED die 301 may be transferred from the LED die 301 to the substantially transparent liquid 304. The heat generated by the LED die 301 may be conducted by the liquid 304. Because a portion of the liquid 304 may be heated by the heat generated from the LED die 301, thermal convection may occur, where heat may be transferred throughout the liquid 304 enclosed in the substantially transparent vessel 305 to the first and second heat-dissipating elements 303, 307.

The LED die 301 and the substantially transparent liquid 304 may be enclosed within the substantially transparent vessel 305. The substantially transparent vessel 305 may be made from a plastic, glass, or a combination thereof, and may allow light emitted from the LED die 301 to be transmitted outside the LED package 300. The substantially transparent vessel 305 may be dome-shaped, cylindrical, rectangular, or any other shape that may enclose the substantially transparent liquid 304 and the LED die 301 within the substantially transparent vessel 305.

The first and second heat-dissipating elements 303, 307 may be heat sinks in an embodiment. The first heat-dissipating element 303 may be connected to an open end of the substantially transparent vessel 305, thereby encapsulating the substantially transparent liquid 304 within the substantially transparent vessel 305. The first heat-dissipating element 303 may further be connected to the second heat-dissipating element 307, which may be located opposite the substantially transparent vessel 305 and not in contact with the substantially transparent liquid 304.

The first heat-dissipating element 303 may be at least partially in contact with the substantially transparent liquid 304 and may be configured to dissipate heat away from the LED die 301 through the substantially transparent liquid 304 to the first heat-dissipating element 303. The second heat-dissipating element 307 may be configured to further dissipate heat away from the first heat-dissipating element 303 to the second heat-dissipating element 303 and outside the LED package 300.

The LED package 300 may further comprise the plurality of leads 306. The plurality of leads 306 may be connected to the LED die 301 within the substantially transparent vessel 304 and may run outside the LED package 300 through both the first heat-dissipating element 303 and the second heat-dissipating element 307. The plurality of leads 306 may be made from metal or traces on a printed circuit board. A portion of the plurality of leads 306 may be soaked in the substantially transparent liquid 304.

The fluorescent powder silicone gel layer 302 may be located on the outer wall of the substantially transparent vessel 305. The LED die 301 may emit light and produce heat after being activated by connecting the plurality of leads 306 to a power source. The LED die 301 may transmit light through the substantially transparent liquid 304 and the substantially transparent vessel 305 to and through the fluorescent powder silicone gel layer 302, exciting the fluorescent powder 302. The excited fluorescent powder 302 may function to intensify and/or change the wavelength/color of the light emitted from the LED die 301. The substantially transparent liquid 304 and the substantially transparent vessel 305 may form a barrier between the LED die 301 and the fluorescent powder 302, which may advantageously prevent the fluorescent powder 302 from decomposing and aging due to excessive heat.

FIG. 3B illustrates a cross-sectional drawing of the LED package 300 of FIG. 3A with one or more protrusions 308 on a top surface 309 of the first heat sink 303. In an embodiment, the one or more protrusions 308 on a top surface 309 of the first heat-dissipating element 303 may be in contact with the substantially transparent liquid 304. These protrusions 308 may enlarge the surface area of the top surface 309 that is in contact with the substantially transparent liquid 304, thus further enhancing the efficiency of heat dissipation of the LED package 300. In an embodiment, the one or more protrusions 308 may be dome-shaped, pyramid-shaped, cylindrical, rectangular, or any other shape that may increase the surface area of the first heat-dissipating element 303.

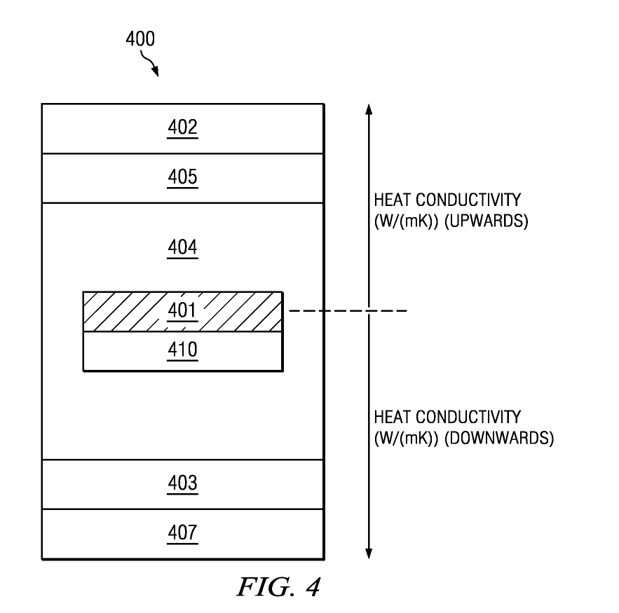

FIG. 4 illustrates a schematic drawing of a heat conduction relationship of the LED package 300 shown in FIGS. 3A and 3B. FIG. 4 shows an LED die 401, a fluorescent powder silicone gel layer 402, a first heat-dissipating element 403, a substantially transparent liquid 404, a substantially transparent vessel 405, a second heat-dissipating element 407, and an LED base 410.

In the LED package 400, the LED die 401 may be attached to the LED base 410. The LED die 401 may generate light (blue, for example) and heat. The LED die 401 may be encapsulated in the substantially transparent vessel 405 and surrounded by the substantially transparent liquid 404. The fluorescent powder silicone gel layer 402 may be applied to the outside of the substantially transparent vessel 405. The light from the LED die 401 may be emitted through the substantially transparent liquid 404 and the substantially transparent vessel 405 to and through the fluorescent powder silicone gel 402, which may change the color of the light (blue light to white light, for example).

The first heat-dissipating element 403 may be at least partially in contact with the substantially transparent liquid 404. The first heat-dissipating element 403 may also be connected to the substantially transparent vessel 405. The second heat-dissipating element 407 may be connected to the first heat-dissipating element 403 to further dissipate heat away from the LED die 404 and the fluorescent powder silicone gel 401. In an embodiment, both the first heat-dissipating element 403 and the second heat-dissipating element 407 may be heat sinks.

As shown in FIG. 4, the direction of heat conduction may travel away from the LED die 401 (i.e., the heat source) in at least two directions. The heat conduction may travel from the LED heat source 401 through the LED base 410, both of which may be surrounded by the substantially transparent liquid 404. The heat may also travel through the substantially transparent liquid 404, traveling “downwards” (i.e., through the bottom of the LED die 401 and the LED base 410) through the first heat-dissipating element 403 and the second heat-dissipating element 407, and traveling “upwards” (i.e., through the top of the LED die 401) to the wall of the substantially transparent vessel 405 to the fluorescent powder silicone gel 402. The heat may travel in other directions as well, but for illustrative purposes downwards and upwards are shown in FIG. 4.

The thermal conductivity (watts per meter kelvin, W/(mK)) of each layer in FIG. 4 may differ. By way of example only, the fluorescent powder silicone gel 402 may have a heat conductivity of 22.0 W/(mK). In an embodiment, the wall of the substantially transparent vessel 402 may be made of plastic and may have a heat conductivity of 0.87 W/(mK). The substantially transparent liquid 404 may be water and may have a heat conductivity of 0.62 W/(mK). The LED base 410 may be made of sapphire and may have a heat conductivity of 42.0 W/(mK). The first heat-dissipating element 403 may be connected to the substantially transparent vessel 405, and in contact with the substantially transparent liquid 404. The second heat-dissipating element 407 may be connected to the first heat-dissipating element 407. Both the first and the second heat-dissipating elements 403, 407 may be made of aluminum and may have a heat conductivity of 237 W/(mK).

Referring now to FIGS. 3A, 3B, and 4, the substantially transparent vessel 305/405 wall and the substantially transparent liquid 304/404 may be present between the LED die 301/401 (i.e., the heat source) and the fluorescent powder silicone gel 302/402. In an embodiment, the wall of the substantially transparent vessel 305/405 and the substantially transparent liquid 304/404 may provide a non-conductive barrier between the LED die 301/401 and the fluorescent powder silicone gel layer 302/402.

Thus, the heat generated by the LED die 301/401 may not be directly conducted to the fluorescent powder silicone gel layer 302/402. This may substantially minimized the decomposing and aging effects of the LED die 301/401 on the fluorescent powder silicone gel layer 302/402. The presence of the first heat-dissipating element 303/403, which may be at least partially in contact with the substantially transparent vessel 305/405, may further enhance this effect. The contact between the first heat-dissipating element 303/403 and the substantially transparent liquid 304/404 may accelerate the heat dissipation from the LED die 301/401 through the substantially transparent liquid 304/404, to the first heat-dissipating element 303/403. The contact between the first heat-dissipating element 303/403 and the second heat-dissipating element 307/407 may further accelerate the heat dissipation from the LED die 301/401 to outside the LED package 300/400, as the second heat-dissipating element 307/407 may provide additional channels of heat dissipation.

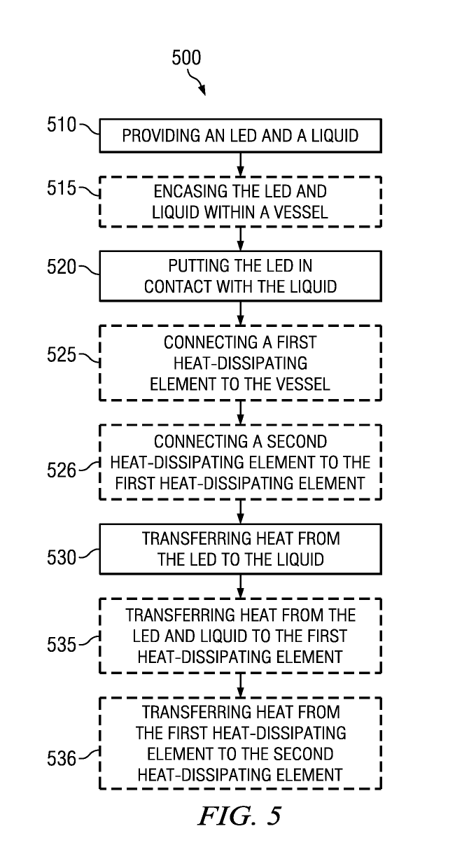

FIG. 5 illustrates a process 500 for cooling the LED packages of FIGS. 3A and 3B by encapsulating an LED die with one or more liquids. At step 510, the LED is put in contact with a liquid. The liquid may be a substantially transparent and electrically non-conductive liquid, and may comprise water, oil, a chemical polymer, or a combination thereof. At step 520, the LED is put in contact with the substantially transparent liquid. At step 530, heat generated by the LED is transferred from the LED to the liquid. The cooling process 500 is a continuous process, wherein steps 510, 520, and 530 may occur concurrently and not sequentially.

In some embodiments, at step 515, the LED and the liquid may be enclosed in a vessel. The vessel may be a substantially transparent vessel. In some embodiments, at step 525, a first heat-dissipating element may be connected to the vessel. The first heat-dissipating element may be a heat sink. At step 535, heat from the LED and the liquid may be transferred to the first heat-dissipating element, wherein the first heat-dissipating element is at least partially in contact with the liquid. The first heat-dissipating element may be provided with one or more protrusions on a surface of the first heat-dissipating element in contact with the liquid, increasing the surface area of the first heat-dissipating element that is in contact with the liquid. Increasing the surface area of the first heat-dissipating element that is in contact with the liquid increases the efficiency of the first heat-dissipating element.

In some embodiments, at step 526, a second heat-dissipating element may be connected to the first heat-dissipating element. The second heat-dissipating element may be a heat sink. At step 536, heat from the first heat-dissipating element may be transferred to the second heat-dissipating element,

In some embodiments, a plurality of leads may be connected to the LED and the LED and the leads may be soaked in the liquid within the vessel. The plurality of leads may be made of metal or traces on a printed circuit board.

While various embodiments have been described above, it should be understood that they have been presented by way of example only, and not limitation. Thus, the breadth and scope of a preferred embodiment should not be limited by any of the above described exemplary embodiments, but should be defined only in accordance with the claims and their equivalents for any patent that issues claiming priority from the present provisional patent application.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method of cooling a light emitting diode, the method comprising:
providing the light emitting diode;
providing a liquid;
putting the light emitting diode in contact with the liquid; and
transferring heat generated by the light emitting diode from the light emitting diode to the liquid.

2. The method of claim 1, further comprising:
providing a vessel; and
enclosing the liquid and the light emitting diode within the vessel.

3. The method of claim 2, wherein the vessel is substantially transparent.

4. The method of claim 2, further comprising:
providing a first heat-dissipating element;
connecting the first heat-dissipating element to the vessel; and
transferring the heat from the light emitting diode and the liquid to the first heat-dissipating element, wherein the first heat-dissipating element is at least partially in contact with the liquid.

5. The method of claim 4, further comprising increasing a surface area of a surface of the first heat-dissipating element that is in contact with the liquid by providing one or more protrusions on the surface.

6. The method of claim 5, wherein increasing the surface area of the surface of the first heat-dissipating element that is in contact with the liquid increases efficiency of the first heat-dissipating element.

7. The method of claim 4, further comprising:
providing a second heat-dissipating element connected to the first heat-dissipating element; and
transferring the heat from the first heat-dissipating element to the second heat-dissipating element.

8. (canceled)

9. The method of claim 1, further comprising:
providing a plurality of leads;
connecting the plurality of leads to the light emitting diode; and
soaking the light emitting diode and the plurality of leads in the liquid.

10. (canceled)

11. The method of claim 1, wherein the liquid is substantially transparent.

12. (canceled)

13. The method of claim 1, wherein the liquid comprises water, oil, a chemical polymer, or a combination thereof.

14. A light emitting diode package, the package comprising:
a liquid; and
a light emitting diode in contact with the liquid;
wherein heat generated by the light emitting diode is transferred from the light emitting diode to the liquid.

15. The light emitting diode package of claim 14, further comprising a vessel, wherein the liquid and the light emitting diode are enclosed within the vessel.

16. The light emitting diode package of claim 15, wherein the vessel is substantially transparent.

17. The light emitting diode package of claim 15, further comprising a first heat-dissipating element connected to the vessel and at least partially in contact with the liquid, wherein the first heat-dissipating element is configured to transfer heat from the light emitting diode and the liquid to the first heat-dissipating element.

18. The light emitting diode package of claim 17, further comprising one or more protrusions on a surface of the first heat-dissipating element in contact with the liquid, wherein the one or more protrusions increase the surface area of the first heat-dissipating element that is in contact with the liquid.

19. The light emitting diode package of claim 17, further comprising a second heat-dissipating element connected to the first heat-dissipating element, wherein the second heat-dissipating element is configured to transfer heat from the first heat-dissipating element to the second heat-dissipating element.

20. (canceled)

21. The light emitting diode package of claim 14, further comprising a plurality of leads connected to the light emitting diode, wherein the light emitting diode and the plurality of leads are soaked in the liquid.

22. (canceled)

23. The light emitting diode package of claim 14, wherein the liquid is substantially transparent.

24. (canceled)

25. The light emitting diode package of claim 14, wherein the liquid comprises water, oil, a chemical polymer, or a combination thereof.

26. The light emitting diode package of claim 14, further comprising a layer located on an outer wall of the vessel, wherein the layer is at least partially comprised of a fluorescent powder.
